(19) United States
(12) Patent Application Publication
(10) Pub. No.: US 2018/0144183 A1
(43) Pub. Date: May 24, 2018

(54) METHOD FOR IDENTIFYING A SECURITY PATTERN USING AN ARTIFICIAL 3D RECONSTRUCTION

(71) Applicant: Friedrich KISTERS, Kreuzlingen (CH)

(72) Inventor: Friedrich KISTERS, Kreuzlingen (CH)

(21) Appl. No.: 15/568,390

(22) PCT Filed: Apr. 21, 2016
(86) PCT No.: PCT/EP2016/058872

§ 371 Date: Oct. 20, 2017

(30) Foreign Application Priority Data
Apr. 21, 2015 (DE) 10 2015 106 081.7

(51) Int. Cl. G06K 9/00; G06K 9/62; G06T 15/20; G06K 9/34; G06K 9/20

(52) U.S. Cl. CPC G06K 9/00201; G06K 9/6202; G06T 15/205; G06K 9/2036; G06K 9/34; G06K 9/00577; G06K 9/623

(57) ABSTRACT

The present invention relates to a method for identification a security pattern by converting two-dimensional (2-D) images or a real existing 3-D model into an artificial three-dimensional (3-D) reconstruction via an analysis of the surface structures, colour information (colour and/or colour intensity), and depth information of the detected security pattern. The method is characterized by the following steps:
generating an elevation model by determining the surface normal per pixel for the three coordinate axes (x, y, z) from the detected 2-D images or the 3-D model,
analyzing the pixel intensity of the detected 2-D images or the 3-D model on the basis of the shadow and the reflection behaviour, and
generating the artificial 3-D reconstruction from the pixel intensity,
   wherein a non-reproducible artificial 3-D surface is generated according to the pixel intensity or the brightness level. The colour information obtained in this manner is incorporated into the depth information of the artificial 3-D reconstruction.

### TECHNICAL AREA

The present invention relates to a method for identifying a security pattern by converting several two-dimensional images (2-D images) or a real 3-D model corresponding to the security pattern into a modified artificial three-dimensional reconstruction (3-D reconstruction).

### PRIOR ART

The representation of three-dimensional height information from previously generated two-dimensional data has long been used, for example, in navigation systems (WO 2007/031361 A1) or in the medical field for contour visualization (DE 10 2012 200 536 A1). In the security area, however, the use of two-dimensional data for authentication is riddled with security problems. For example, recording a fingerprint or the iris of a human eye is sufficient to generate an identical reconstruction of such a biometric security feature. A hacker or an imitator can thus easily gain access to a secured system. In order to avoid these disadvantages, a method and a device are proposed in DE 10 2004 041 115 A1, by means of which an increased counterfeit protection should be made possible, wherein the object is detected simultaneously or almost simultaneously from at least two different capturing directions. In this case, all points of the surface to be imaged are depicted in at least two different directions and are each depicted in a digital two-dimensional image. From these images, a three-dimensional model of the observed object is calculated. Each point of the surface to be imaged is depicted in two different directions, so that the entire shell surface of a finger or a hand or other body part is imaged without contamination. This method thus provides an image of the surface identical to the real body part.

In DE 10 2013 212 827 A1 a method and a device for the optical former acquisition and/or testing of an object are described, in which image sequences of an object surface are recorded with a camera under different recording conditions. From the data, local surface inclinations at the object sites are calculated from the position of the respectively corresponding image location in the image plane.

Also known are methods, in which 3-D colour effects are produced. For example, DE 10 2011 005 518 A1 describes a security element with a 3-D colour effect which, for verification purposes, uses a graphical information consisting of different information parts. For example, electromagnetic radiation of different wavelengths is used for a reflection or transmission, in order to achieve such a 3-D colour effect.

DE 10 2008 032 781 A1 describes a method for the authentication of products, in which the product is packaged with a packaging film, which contains randomly distributed pigment particles. From the relative positional coordinates and colour values of the selected pigment particles, an identification code can be derived by means of an encryption algorithm.

In addition, the methods for authenticating objects are also known, in which test image data are generated, which represent the characteristic properties of the object surface of the test object to be tested in the test area. For this purpose, a comparison method is used in DE 10 2012 205 347 A1, in which a vector field of similarity vectors is calculated for a predetermined number of measurement points by means of a cross-correlation analysis calculation, whereby the vectors point to singular points of a local correlation coefficient field calculated in the measurement point surroundings. The decisive factor here is that third-image data are generated, which represent a third image which differs from the reference image. This process step can be carried out before or after the reference acquisition or simultaneously with the latter.

DE 10 2010 046 219 A1 describes a method and a device for detecting three-dimensional raised structures on a surface of a document, in which the surface is first illuminated with light, an image of the surface is recorded, and then the acquired image is evaluated for determining the raised structures. In this case, the surface is laminarily illuminated in at least two different ways, and at least one two-dimensional image of the surface is recorded for each of the different types of illumination. Then, the two-dimensional images of the surface thus acquired are jointly evaluated. The surface can be illuminated in different ways, for example, by illuminating the surface from different directions with light under grazing angle of incidence. When evaluating, preferably at least two of the different images are compared with each other, in order to determine the raised structures on the basis of the detected differences. In this case, impact shadows and/or reflection profiles are explicitly isolated, in order to obtain an authentic image of the surface as possible.

While the known methods are aimed at capturing a three-dimensional surface as faithfully as possible, for example by means of different scanning methods or by the conversion of two-dimensionally recorded images, there is still a safety risk when such structures are imitated by a forger. Even in the case of a transformation into a three-dimensional model, a counterfeiting would not differ from the original and the authentication query would therefore proceed positively.

### DESCRIPTION OF THE INVENTION

Against this background, it is an object of the present invention to provide an improved, security-enhancing method for identifying a security pattern on the basis of a 3-D reconstruction, which allows for an identification of, for example, an object or a person.

This object is achieved by a method having the features of claim 1. Preferred embodiments are part of the dependent claims.

The method according to the present invention is based on the idea either to convert a plurality of 2D images of the surface of a security pattern or to convert a real three-dimensional image (3-D model) of the security pattern via an analysis of the measured surface intensities and colour information (e.g. colour and/or colour intensity) taking into account the pixel intensities into an artificial 3-D reconstruction.

In doing so, a mathematical approach is made, which makes it possible to create a new, artificial three-dimensional image of the security pattern from the so-called pixel albedo. The artificial three-dimensional reconstruction obtained in this way differs from the real three-dimensional reconstruction, since additional information is incorporated into the image generation for the creation of artificial 3D reconstruction. The artificial 3-D reconstruction is finally compared with a 3-D reference image stored in a database. Alternatively, the reference features extracted therefrom can also be compared with corresponding reference features and possible changes can be determined. The tolerance range for changes is defined in advance. For a positive comparison, the authentication process runs positive.

A security pattern for the purpose of the present invention is a random element, which bears the security features that are used for authentication or identification.

In a first method step, the 2-D variant which is based on two-dimensional images is firstly subjected to a multiple detection of two-dimensional (2-D) images of the surface of a security pattern under different recording conditions with at least one optical scanning device. The scanning device can, for example, be a conventional camera, the surface being illuminated by differently arranged illumination devices. Thus, the images of the security pattern can be generated using a detection process with different detection angles and/or wavelengths and/or polarizing filters during scanning and/or a different number, type or arrangement of lighting devices. The different shadow casts and the reflection behaviour of the surface result in 2-D images, in which each pixel can have a different intensity or colour information.

In an alternative variant, a real three-dimensional reconstruction of the security pattern already exists (3-D model), so that a multiple detection of 2-D images is dispensable. The real 3-D model includes the three-dimensional elevation model of the security pattern and is then changed in the manner according to the invention.

For this purpose, either the detected 2-D images or the provided real 3-D model of the security pattern are converted into an artificial 3-D reconstruction. This is first done by analyzing the measured surface intensities and/or colour information (for example colour and/or colour intensity). In addition to the spatial, three-dimensional (3-D) information along the x, y and z axes, vector information such as the colour scheme, the luminosity of the pixels, or other technical parameters can also be included in the 3-D reconstruction.

According to the invention, for this purpose, a height model is first determined by determining the surface normal per pixel for the three coordinate axes X, Y, Z from the previously acquired 2-D images or the 3-D model. The following is a calculation example.

For the registered image intensity, the following applies:

I(x,y)=c·q(x,y,z)·R(n,s)

where: I (x, y)=registered image intensity at the point (x, y); c=sensitivity of the camera; q (x, y, z)=position of the light source at the point (x, y, z); R (n, s)=reflection behaviour of the surface as a function of the local orientation n and the direction of light s; p=(global) albedo of the surface

Lambert's reflection model:

R(n,s)=p·cos φ=·(n,s)

For camera sensitivity=brightness of the light source=(global) albedo=1:

I=cos φ=<n,s>

With calibrated light directions the following results for the Lambert case:

$$( \begin{matrix}{l}_{1} ( x , y ) \\ {l}_{2} ( x , y ) \\ {l}_{3} ( x , y ) \\ {l}_{4} ( x , y )\end{matrix} ) = p ( \begin{matrix}{S}_{11} & {S}_{12} & {S}_{13} \\ {S}_{21} & {S}_{22} & {S}_{23} \\ {S}_{31} & {S}_{32} & {S}_{33} \\ {S}_{41} & {S}_{42} & {S}_{43}\end{matrix} ) ( x , y )$$

For det(S) I=0 corresponds to the surface norms:

$$n ( x , y ) = \frac{1}{P} {S}^{- 1} \vert ( x , y )$$

As well as the albedo by:

p(x,y)=∥S⁻¹|(x,y)∥

The elevation model is finally created by a local or global integration of the gradient field.

Thus, an analysis of the measured intensity per pixel and a determination of the reflectance of the recorded security pattern are carried out. This includes a validation of the surface and depth information of the security pattern, the roughness of the surface structure, and a determination of the pixel albedo.

Finally, an artificial 3-D reconstruction is produced from the previously produced surface normal, whereby corresponding to the reflective behaviour of the surface and the intensity of the surface marking a non-reproducible artificial three-dimensional surface is formed, which differs from the real three-dimensional surface of the security pattern. The differences can, for example, relate to the structure, elevations, depressions, the colour, the arrangement or the change of one or more features of the security pattern. For example, if the security pattern superimposed by a colour layer, the reflection behaviour of each pixel is affected by it. The same also applies if at least partially infrared-reflecting colouring agents or mixtures of different infrared-reflecting colouring agents, optionally with non-reflective colouring agents, are used on a surface. Thus, as a result, the inventive method provides a virtual, artificial and therefore not reproducible model, which is unique. The lack of reproducibility makes it virtually impossible for a counterfeiter to create a security pattern, which has exactly the same properties as the derived artificial 3-D reconstruction.

The obtained artificial 3-D reconstruction is converted into a data set and during an authentication it is compared with a reference data set of the security pattern stored in a database. If there is a match in this comparison, a positive authentication of the security pattern is given. As is customary, a certain threshold value or tolerances can be defined in such a “match” authentication. Preferably, the obtained 3-D reconstruction can be stored as a new 3-D reference image in the database. For comparison, either the entire 3-D reconstruction or individual characteristics extracted therefrom can be used.

If a plurality of light sources are used in the detection of 2-D images of the surface of the security pattern (e.g. four light sources), then for determining the light direction, it is necessary that prior to the multiple detection of the 2-D images, a unique calibration step of light direction is performed prior to recording using a dedicated calibration object. This calibration object is a geometric object with a defined physical quantity, for example, a hemisphere. The light direction can be determined with the help of the calibration object. In a preferred variant, the detection is performed with at least three light sources, preferably four light sources. These can, for example, be arranged in a square or rectangle around the optical scanning device and directed towards the surface to be illuminated. The light emitted by the light sources is preferably polarized. If the position of the camera is changed, a new calibration step should be carried out. If the system consists of light sources and scanning devices, the calibration data can be firmly integrated into the detection device and can be used for subsequent measurements. The individual light sources can be wired with different wavelengths, for example, with standard light or IR light, in order to highlight or hide individual features of the security pattern.

In a preferred embodiment variant, it is provided that the optical scanning device has an optics with different focal lengths, so that the detection field can be varied during 2-D imaging. A macro or a zoom optics, for example, is also conceivable. This has the advantage that targeted recording areas or objects of the security pattern can be recorded. Monochrome and colour optics can be used in optics. In a preferred variant, a light field camera can also be used as optical scanning device, in order to detect the 2-D images of the surface of the security pattern.

In a further embodiment it is provided that the security pattern is detected using additional optics (for example, magnification optics), by placing a lens, a disk or a glass on the security pattern. In this case, the additional optics can be adapted specifically for the recording of this security pattern, in order to obtain individualized recording results. The safety can also be increased in that the glass of the optics has special properties, for example, a specific lens thickness or focal length. Also, a magnifying glass which is to be applied to the security pattern can be at least partially coated, polarized or shadowed, which has an effect on the reproduction of the 2-D image and thus the subsequent 3-D reconstruction. In such a variant, an individualized additional optics, which is applied to the security pattern, is provided during the detection of the 2-D image of the surface of the security pattern. The individualization during the scanning is determined, for example, by the choice of the focal length, the lens thickness, at least partially shading, polarization or colouring or surface characteristics in the structure of the additional optics.

Depending on the type of application, it is possible that the imaging optics does not display the security pattern sharply when recording the object. In such a case, it is provided that the security pattern is imaged with different focusing planes. For example, three or more focus planes can be imaged by the security pattern. The individual sharply-imaged areas can then be assembled by means of image processing. This is advantageous for example in the case of curved or corrugated security patterns, or in the case of security patterns, which are applied to a cylindrical container and are scanned by a scanner.

In order to prevent shading during detection, four or more light sources, for example LEDs, can be provided, which are arranged around the imaging object and illuminate the surface thereof. While detecting the security pattern in different focal planes, illumination with 6, 8 or more LED light sources may also be required, and it may be necessary to provide the light as well as the objective with polarizing filters so as to suppress reflections. It is possible that characteristics appear only under polarized light. Preferably, cross-polarization attempts are made to reduce the reflections. In this approach, a linear polarizing filter is mounted in front of the camera and crossed linear polarizing filters are arranged in front of the LEDs (for example, with polarizing film).

Compared to the known methods, the process according to the invention is based, inter alia, on the fact that characteristics are compared, which, in other methods, are not used at all for an examination and which can influence one another.

In order to exclude primitive counterfeits or to perform a pre-selection, it is provided according to the invention that after the multiple detection of the 2-D images and prior to the conversion of the 2-D images into an artificial 3-D reconstruction, a pre-filtering of the previously detected security pattern is performed via a correlation comparison of the detected 2-D image with a reference image of the security pattern stored in a database. In such a correlation comparison, e.g. the colour, the colour intensity or the optical impression of the images can be used. In such an embodiment, therefore, characteristics which are no longer analyzed in this form in the subsequent method steps are thus compared in the course of the pre-filtering. Preferably, the method of normalized cross-correlation is used in pre-filtering. In addition, however, it is also possible to use distinctive image features for image comparison. Finally, a comparison of the colour distribution over a histogram is possible.

In a further preferred method step, it is provided that after the detection and alignment of the security pattern with the scanning device, a segmentation of the image information of the security pattern detected with the scanning device is carried out, in which the distinctive image features of the security pattern are released from the recording background. The segmentation involves the generation of contextually contiguous image regions by matching adjacent pixels corresponding to a particular homogeneity criterion. Various methods can be used, such as pixel-oriented methods and special segmentation algorithms. A primitive counterfeit can also be easily identified by the sole examination of the segmentation.

In a further variant, it is provided that, after the segmentation of the security pattern, a skeletonising of the prominent image features takes place with consideration of a stray error in the image analysis. In the case of skeletonising, a flat image object is converted into a skeleton line which is exactly one pixel wide. Thus, for example, the wide image inscriptions are diluted or cracks reduced. It is also advantageous in the case of skeletonising if, for example, a threshold value has previously been defined.

Preferably, the previously skeletonised image features are compared by means of a distance transformation with a data record of the security pattern stored in a database, taking into account a threshold value.

The method according to the invention allows analysis of very fine surface structures and thus a high accuracy in the reconstruction. By checking the pixel albedo, counterfeits can be easily detected in this analysis step. Although the pixel albedo is a by-product of the method according to the invention, it can be excellently used for a safety analysis.

The reflection behaviour of the security pattern or parts thereof can be influenced by the adding of colours or colour mixtures, which have different reflective properties at different wavelengths. For example, it is possible to add at least partially infrared (IR)-reflective colouring agent to the security pattern or a part thereof. If only areas of the security pattern are dyed with the infrared reflecting colouring agent, a completely different virtual image (3-D reconstruction) of the security pattern is obtained. In a variant, it is also possible that areas of the security pattern are coated with a homogeneous mixture of an IR-reflective substance and a non-IR-reflective substance, so that a different reflection behaviour occurs in these regions. The same also applies to the case of overlaps of different colouring agents. In a further variant, it can be provided that an IR-reflecting colouring agent is influenced in its reflection behaviour by a layer which is above or underneath, for example a varnish layer, which at least partly covers the IR colouring agent and blocks the IR rays. Preferably, the reflection behaviour of the IR-reflective colouring agents of the security pattern are influenced through an underlying or overlying layer, for example a varnish layer, so that a changed shadow cast results in, which affects the appearance of the resulting artificial 3D reconstruction.

An analysis can, for example, be made more difficult by applying a mixture of IR-reflecting colouring agents and additional non-IR-reflecting colouring agents on a surface. Surface inscriptions can also be carried out using infrared-reflecting colouring agents or different colour mixtures and colouring agent concentrations.

The colour information thus obtained flows into the depth information of the artificial 3-D reconstruction. This creates a virtual surface which is not reproducible by scanning the real surface. The colour information generates different shadow casts, which is reflected in different reflective behaviour. That is, colour properties or different shadow casts generate different surface characteristics. Surface inscriptions or surfaces (for example, above or underneath layers) can be either IR-reflective, IR-partial-reflective or non-IR-reflective and possibly have different unevenness. A possible forger does not know which colouring agent and in what concentration it was used to colour the security pattern. The counterfeiter can also not know which structures of the 3-D reconstruction are caused by the structure and thus the shadow cast of the security pattern and by the reflection behaviour of the colours or colour mixtures.

The scanning can take place with light of different wavelengths and, if necessary, with the aid of polarizing filters, which additionally increases safety. So a scanning can take place under IR light and/or UV light and/or another wavelength with or without polarizing filters. Thereby different types of readouts can also be combined with one another. In the case of a dynamic further development of the security pattern, for example a coating or varnish layer, different results are obtained in the 3-D reconstruction generated by the method according to the invention.

In a preferred embodiment, the security pattern is arranged in or below a varnish layer or is covered by a varnish layer. Preferably, the varnish layer has a further safety pattern in the form of cracks, fissures or elevations, wherein the safety pattern and the properties of the varnish layer (for example, its surface, layer thickness, colour) exhibit identical characteristic shadow cast and a characteristic reflective properties during the generation of the artificial 3-D reconstruction.

A model is thus obtained from the depth information and the pixel albedo, which is converted into an artificial 3-D reconstruction with a new surface structure and depth information according to the existing intensity differences. In a preferred variant, the artificial 3-D reconstruction of the security pattern is provided as pixel information, wherein the position, relative arrangement and/or colour information are stored as pixels in a data set.

In order to further increase the security of the stored data, it may be provided in a preferred variant that the pixel information stored in the data record is at least partially changed by a factor so that changed pixel information is generated, which corresponds to a modified artificial 3-D reconstruction. Such a factor may, for example, be an algorithm, which includes a recalculation or conversion of the data of the virtual 3-D reconstruction, as obtained.

In a further variant, it is possible that the obtained artificial 3-D reconstruction is reduced again to specific safety features-carrying elements. Preferably, such elements are selected and analyzed, which are suitable for an analysis and analysis evaluation of the safety features. From the artificial 3-D reconstruction, two-dimensional or multi-dimensional elements altered via the Pixel albedo can be specifically filtered out.

### WAYS OF CARRYING OUT THE INVENTION AND COMMERCIAL USABILITY

The invention is explained in more detail in the following exemplary embodiments.

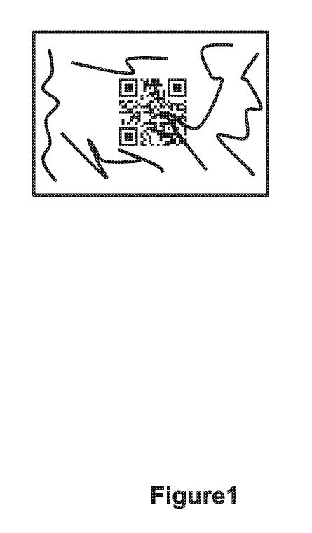

FIG. 1 shows a security pattern in the form of a QR-code. One of the arguably greater problems of three-dimensional security features is their low security against counterfeiting with respect to the available high-precision 3-D printers. With the aid of such printers, arbitrary surfaces can be read in and reproduced correspondingly, in particular if the colour/material composition of the original is known.

In the present exemplary embodiment, a layer read-out method is used, which is based on a completely or partly infrared-reflective colour. The QR-code printed with this colour is wholly or partly coated with a transparent varnish. In the present exemplary embodiment, it is a clear varnish, which also has cracks in the form of a crackle pattern. The colour of the QR-code is completely or partially reflective in infrared light.

With the help of an optical recording device, different 2-D images are recorded, in which the light comes from different directions. For this purpose, the illumination sources (in the variant shown, four illumination sources (for example LEDs) are used) are arranged around the object and activated one after the other, so as to produce a 2-D image in each case. Using the 2-D images obtained by means of the different exposure sources, the 3-D reconstruction of the surface of the clear varnish is generated in the manner according to the invention. The colour of the QR-code visible in the infrared region has an influence on the virtual 3-D reconstruction of the surface. The layer thickness and the homogeneity of the distribution of the varnish on the surface also have an influence on the 3-D structure formation.

The safety sticker shown thus results in a virtual 3-D surface which does not coincide with the real surface, but results in a modified 3-D reconstruction, thanks to the method according to the invention.

The read-out operation can, of course, be reproducible, so that a re-scanning of the surface leads to an identical copy of the 3D reconstruction, wherein especially in the case of a dynamic safety feature, tolerances can be installed which deliberately allow for a change margin, without however simplifying the counterfeiting ability.

A counterfeiter would, therefore, have to copy exactly the reflection behaviour of the colours in normal and infrared light (and, if applicable, other light spectra), even if it relates to several overlapping colour layers. Simply scanning or copying the visible surface is not enough. This makes a copy almost impossible.

The security can be further increased by dynamically changing the colour layer itself, for example by fading out or by the formation of cracks or the chippings in the layer.

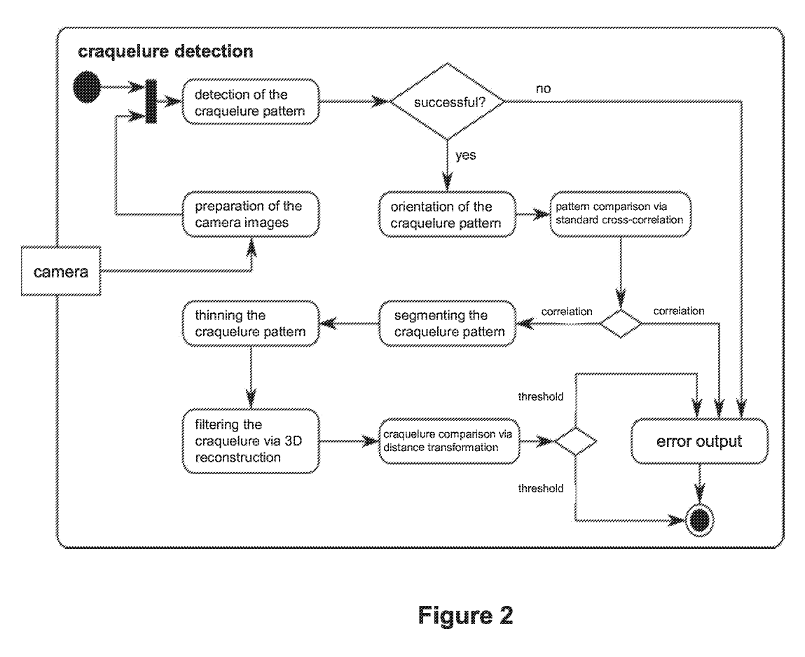

FIG. 2 shows a variant for a crackle detection, in which a clear varnish layer has a crackle in the form of cracks, fissures or break-outs. First, the crackle pattern is detected. If this is successful, then the crackle pattern is aligned, and pre-filtration is carried out via normalized cross-correlation. If a negative result is present during these analysis steps, a fault output or an alarm is signalled.

In normalized cross-correlation, a threshold value is also established, which represents the degree of consistency. If the correlation in the example shown is greater than the value 0.7, then the method according to the invention is continued, and segmentation is followed by a thinning of the crackle pattern. Finally, the crackle pattern is filtered via a 3-D reconstruction, in which an artificial 3-D surface is generated in the manner as described above. Finally, in the embodiment variant shown, a crackle comparison is made via a distance transformation, wherein a threshold value is determined with respect to the degree of consistency.

It is, therefore, almost impossible for a counterfeiter to imitate the 3-D reconstruction by artificial 3-D reconstruction method according to the invention, since it must know all the parameters of the original and have to apply them identically, in order to counterfeit them. A counterfeiter does not know, in particular, what colours are used in which concentrations and on which carrier material the security code is applied. Further, it is extremely complex to recreate such a random distribution, if it must simultaneously be brought into the correct relationship with three-dimensional features such as, for example, real crackle cracks. Further, he does not know the surface characteristics of the 3-D pattern and its influence on the inscription (or vice versa). By means of the inventive exposure, a unique pixel albedo (reflectance) per pixel is also generated, which is not known to the counterfeiter. For this purpose, it should be in the possession of the same calibrated and gauged recording device as well as the original safety element, in order to produce theoretically identical results.

By adding a random varnish distribution, each security feature can be further customized. By incorporating dynamic changes in this layer (e.g., by fading or progressively forming cracks), the counterfeiting of the individualized security pattern is impossible.

1. A method of identifying a security pattern comprising the steps of:
a) detecting two-dimensional (2-D) images of the surface of a security pattern under different recording conditions with an optical scanning device, or providing a real three-dimensional (3-D) model of the security pattern,
(b) converting the acquired 2-D images or the real 3-D model into an artificial 3-D reconstruction via an analysis of the surface structures, colour information (colour and/or colour intensity) and depth information of the detected security pattern comprising
creating a height model by determining the surface normal per pixel for the three coordinate axes (x, y, z) from the acquired 2-D images or the 3-D model,
analysis of the pixel intensity of the detected 2-0 images or of the 3-D model due to the shading and reflectivity characteristics, and
creating the artificial 3-D reconstruction from the pixel intensities whereby, according to the pixel intensity or the degree of brightness, a non-reproducible artificial 3-D surface is formed, in which the obtained colour information flows into the depth information of the artificial 3-D reconstruction.
c) comparison of the thus obtained artificial 3D reconstruction with a 3-D reference image of the security pattern stored in a database.

2. The method according to claim 1, wherein
multiple detection of two-dimensional (2-D) images of the surface of a security pattern under different recording conditions with an optical scanning device, and
pre-filtering the detected security pattern by correlating a detected two-dimensional (2-D) image of the security pattern with a 2-D reference image of the security pattern stored in a database,
wherein in the case of a positive correlation during pre-filtration, the conversion of the 2-D image into the artificial 3-D reconstruction takes place by means of an analysis of the surface structures, colour information (colour and/or colour intensity) and depth information of the detected security pattern.

3. The method according to claim 1, wherein the detection of the 2-D images with different detection angles and/or wavelengths and/or polarizing filters takes place during scanning and/or a different number, type or arrangement of the illumination devices.

4. The method according to claim 1, wherein after the detection and, if necessary, the alignment of the security pattern with the scanning device, a segmentation of the image information of the security pattern detected by the scanning device takes place, in which the surface details of the detected security pattern are released from the recording background.

5. The method according to claim 4, wherein after segmentation of the security pattern, a skeletonising of the image information of the security pattern takes place with consideration of random imperfections in the image analysis.

6. The method according to claim 1, wherein the comparison of the artificial 3-D reconstruction of the security pattern with the 3-D reference image is carried out via a distance transformation on the basis of a threshold value.

7. The method according to claim 1, wherein the security pattern, or parts thereof, is generated by adding at least partially infrared (IR)-reflective colouring agent or a mixture of infrared (IR)-reflecting colouring agents and additional non-IR-reflecting colouring agents on a surface, whereby a scanning taking place under IR light and/or UV light and/or a different wavelength and/or with the aid of polarizing filters.

8. The method according to claim 7, wherein the reflection characteristics of the IR-reflective colouring agents of the security pattern is influenced by an underlying or overlying varnish layer, so that a changed shadow cast is arised, which has an effect on the appearance of the resulting artificial 3-D reconstruction.

9. The method according to claim 7, wherein the security pattern is located in or below a varnish layer or is covered by a varnish layer, whereby the varnish layer has a further security pattern in the form of cracks, fissures or elevations, whereby the security patterns and properties of the varnish layer (such as the surface, layer thickness, colour) with identical recording conditions result in a characteristic shadow casting and back-reflection behaviour during the production of the artificial 3-D reconstruction.

10. The method according to claim 1, wherein a light/dark model is obtained from the depth information as derived and the pixel albedo of each individual pixel, which, according to the existing brightness differences, is converted into an artificial 3-D reconstruction with new surface characteristics and depth information.

11. The method according to claim 1, wherein the artificial 3-D reconstruction of the security pattern is present as pixel data, the position, relative arrangement and/or colour information of individual pixels are stored in a data set, whereby the pixel information stored in the data set via an algorithm, a code or a rule are modified at least partially, so that changed pixel information is generated which corresponds to a changed artificial 3-D reconstruction.

12. The method according to claim 1, wherein during the detection of the 2-D image of the surface of the security pattern, an individualized additional optics is provided which is applied to the security pattern, whereby individualization during scanning, for example, by selecting the focal length, lens strength, at least partial shading, polarization or colouring or surface characteristics in the structure of the additional optics.

13. The method according to claim 1, wherein an analysis of the measured intensity per pixel and a determination of the reflectivity of the recorded security pattern are carried out for validating the surface and depth information of the security pattern, taking into account the roughness of the surface structure and determination of the pixel albedo.

14. The method according to claim 1, wherein from the obtained 3-D reconstruction and from the comparison with the 3-D reference image of the security pattern, specific elements bearing safety features are filtered out and are compared.
